(19) United States
(12) Patent Application Publication
(10) Pub. No.: US 2019/0122031 A1
(43) Pub. Date: Apr. 25, 2019

(54) DEVICES, SYSTEMS AND METHODS FOR PRIVACY-PRESERVING SECURITY

(71) Applicant: INTERDIGITAL CE PATENT HOLDINGS, PARIS (FR)

(72) Inventors: Brian Charles Eriksson, San Jose, CA (US); Ajith Pudhiyaveetil, Sunnyvale, CA (US); Akshay Pushparaja, Mountain View, CA (US)

(21) Appl. No.: 16/167,733

(22) Filed: Oct. 23, 2018

Related U.S. Application Data
(60) Provisional application No. 62/576,851, filed on Oct. 25, 2017.

(51) Int. Cl. G06K 9/00; G08B 13/196

(52) U.S. Cl. CPC G06K 9/00288; G08B 13/19602; G06K 9/00926

(57) ABSTRACT

The present disclosure provides devices, systems, and methods for providing privacy-preserving security using dormant computing power within a dwelling or building. In one aspect of the present disclosure, the devices, systems, and methods include a processor that receives at least one image captured within a premises, detects at least one face in the at least one image, determines if the detected at least one face matches at least one known face in a database and, if the detected at least one face does not match a known face, transmits a notification to at least one second device. In another aspect of the present disclosure, the processor determines a number of unique faces present in the at least one image and, if the determined number of unique faces is above a limit, transmits a notification to at least one second device.

### TECHNICAL FIELD

The present disclosure generally relates to home networking and communication systems. More particularly, the present disclosure is related to devices, systems and methods for privacy-preserving security.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

As cameras become cheap and ubiquitous, the push towards camera-based in-home services increases. Until now, most in-home camera-based solutions have involved the application of home security. Unfortunately, these solutions are limited by two factors. The first is that many applications use the camera system in conjunction with a manned dispatch center, creating difficulties scaling these solutions. The second is that by sending in-home images and video to a manned dispatch center, there is large amount of privacy the consumer gives up by using these systems. The result is systems that are expensive to maintain and undesirable for the consumer.

### SUMMARY

Devices, systems and methods for privacy-preserving security are provided.

In one aspect of the present disclosure, a method is provided including receiving, by a processor of a first device, at least one image captured within a premises; detecting, by the processor, at least one face in the at least one image; determining, by the processor, if the detected at least one face matches at least one known face in a database; and if the detected at least one face does not match a known face, transmitting a notification to at least one second device.

In another aspect of the present disclosure, an apparatus is provided including a processor that receives at least one image captured within a premises, detects at least one face in the at least one image, determines if the detected at least one face matches at least one known face in a database and, if the detected at least one face does not match a known face, transmits a notification to at least one second device.

In another aspect of the present disclosure, a method is provided including receiving, by a processor of a first device, at least one image captured within a premises; detecting, by the processor one or more faces in the at least one image; determining, by the processor, a number of unique faces present in the at least one image; and if the determined number of unique faces is above a limit, transmitting a notification to at least one second device.

In another aspect of the present disclosure, an apparatus is provided including a processor that receives at least one image captured within a premises, detects one or more faces in the at least one image, determines a number of unique faces present in the at least one image and, if the determined number of unique faces is above a limit, transmits a notification to at least one second device.

In another aspect of the present disclosure, a method is provided including receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting at least one face in the at least one image, and determining if the detected at least one face matches at least one known face in a database.

In another aspect of the present disclosure, a method is provided including receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting one or more faces in the at least one image, and determining a number of unique faces present in the at least one image.

In accordance with an aspect of the present disclosure, an embodiment comprises a method including: receiving, by a processor of a first device, at least one image captured within a premises; detecting, by the processor, at least one face in the at least one image; determining, by the processor, if the detected at least one face matches at least one known face in a database; and if the detected at least one face does not match a known face, transmitting a notification to at least one second device.

In accordance with another aspect of the present disclosure, an embodiment comprises a method including: receiving, by a processor of a first device, at least one image captured within a premises; detecting, by the processor, one or more faces in the at least one image; determining, by the processor, a number of unique faces present in the at least one image; and if the determined number of unique faces is above a limit, transmitting a notification to at least one second device.

In accordance with another aspect of the present disclosure, an embodiment comprises a method including: receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting at least one face in the at least one image, and determining if the detected at least one face matches at least one known face in a database.

In accordance with another aspect of the present disclosure, an embodiment such as the preceding method may further include: receiving, by the processor of the first device, results of the instructions executed by the at least one second device; and based on the received results, transmitting a notification to at least one third device.

In accordance with another aspect of the present disclosure, an embodiment comprises a method including: receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting one or more faces in the at least one image, and determining a number of unique faces present in the at least one image.

In accordance with another aspect of the present disclosure, an embodiment such as the preceding method may further include: receiving, by the processor of the first device, results of the instructions executed by the at least one second device; and based on the received results, transmitting a notification to at least one third device.

In accordance with another aspect of the present disclosure, an embodiment comprises a method including: receiving, by a processor of a first device, at least one image captured within a premises; determining, by the processor of the first device, an available processing power of the first device; and based on the available processing power of the first device, determining whether to transmit instructions including the at least one image to at least one second device, to execute in the second device at least one of: detecting at least one face in the at least one image, and determining if the detected at least one face matches at least one known face in a database.

In accordance with another aspect of the present disclosure, an embodiment such as the preceding exemplary method may further include: receiving, by the processor of the first device, results of the instructions executed by the at least one second device; and based on the received results, transmitting a notification to at least one third device.

In accordance with another aspect of the present disclosure, an embodiment comprises a method including: receiving, by a processor of a first device, at least one image captured within a premises; determining, by the processor of the first device, an available processing power of the first device; requesting, by the processor of the first device, from a second device an available processing power of the second device; and based on the available processing power of the first device and the second device, determining whether to transmit instructions including the at least one image to the second device, to execute in the second device at least one of: detecting at least one face in the at least one image, and determining if the detected at least one face matches at least one known face in a database.

In accordance with another aspect of the present disclosure, an embodiment such as the preceding exemplary method may further include: receiving, by the processor of the first device, results of the instructions executed by the at least one second device; and based on the received results, transmitting a notification to at least one third device.

In accordance with the present disclosure, an embodiment such as any of the preceding exemplary embodiments comprising a method may further include one or more of the following aspects wherein: the notification includes the at least one image; the at least one second device comprises a display device coupled to the first device; the at least one second device comprises a phone device; the notification includes at least one text message; prompting a user via the notification to add the detected at least one face to the database; prompting a user via the notification to issue a security warning; receiving, by the processor of the first device, may be via at least one of a power line, a wired connection and/or a wireless communication; the first device may be a set-top box; the processor performs the receiving, detecting, determining, and transmitting using only dormant processing power of the processor.

In accordance with another aspect of the present disclosure, an embodiment comprises an apparatus including: a processor that receives at least one image captured within a premises, detects at least one face in the at least one image, determines if the detected at least one face matches at least one known face in a database and, if the detected at least one face does not match a known face, transmits a notification to at least one second device.

In accordance with another aspect of the present disclosure, an embodiment comprises an apparatus including: a processor that receives at least one image captured within a premises, detects one or more faces in the at least one image, determines a number of unique faces present in the at least one image and, if the determined number of unique faces is above a limit, transmits a notification to at least one second device.

In accordance with the present disclosure, an embodiment such as any of the preceding exemplary embodiments of apparatus may further include one or more of the following aspects wherein: the notification includes the at least one image; the at least one second device comprises a display device coupled to the apparatus; the at least one second device comprises a phone device; the notification includes at least one text message; the processor configures the notification to prompt a user to add the detected at least one face to the database; the processor configures the notification to prompt a user to issue a security warning; the processor receives the at least one image via at least one of a power line, a wired connection and/or a wireless communication; the apparatus comprises a set-top box; the processor performs the receiving, detecting, determining, and transmitting using only dormant processing power of the processor.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings, wherein like reference designators indicate the same or similar features, and in which:

FIG. 1 is a block diagram of an exemplary information distribution network for delivering services to a residence in accordance with an embodiment of the present disclosure;

FIG. 2 is a block diagram of an exemplary device in accordance with an embodiment of the present disclosure;

FIG. 3 is a block diagram of an exemplary system including a controller configured for providing privacy-preserving security to a dwelling or building in accordance with an embodiment of the present disclosure;

FIG. 4A is a flowchart illustrating an exemplary method for providing privacy-preserving security to a dwelling or building in accordance with an embodiment of the present disclosure;

FIG. 4B is a flowchart illustrating an exemplary method for determining a number of unique faces present in or around a dwelling or building in accordance with an embodiment of the present disclosure;

FIG. 5 is a block diagram of another exemplary information distribution network for delivering services in accordance with an embodiment of the present disclosure; and

FIG. 6 is a flowchart illustrating an exemplary method for providing a distributed dormant computing scheme to perform the methods of FIGS. 4A and/or 4B in accordance with an embodiment of the present disclosure.

It should be understood that the drawing(s) are for purposes of illustrating the concepts of the disclosure and is not necessarily the only possible configuration for illustrating the disclosure.

### DETAILED DESCRIPTION

It also should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure provides for a privacy-preserving security system using dormant computing power within a dwelling or building. The devices, systems and methods of the present disclosure employ dormant computing power inside a dwelling or building. Specifically, set-top boxes (initially designed for cable or over-the-top (OTT) services) have been increasing in power year-over-year, while the processing demands of the consumer have remained almost constant (e.g., stream HD video and provide a modern UX experience). As a result, many consumers now have a series of powerful computing platforms inside their home, connected to power, and with the ability to perform computing applications (in addition to already-performed computing applications) with little to no degradation of performance apparent to the consumer.

The techniques of the present disclosure exploit the dormant computing power of existing computing devices within a dwelling or building and eliminate the two problems with current security solutions discussed above. First, the systems and methods of the present disclosure implement new image/video processing use cases that will provide the consumer with a desired level of security, while avoiding manned analysis of in-home footage. Specifically, the system and method of the present disclosure analyzes in-home footage, maintains a collection of known individuals in the home, and notifies the user when new individuals have entered the house. Second, the system and method of the present disclosure determines, based on in-home footage, the number of people in or around the home at any given time. Third, the system and method of the present disclosure performs all this image/video processing on existing hardware inside the home via available dormant computing capabilities. The advantages of system and method of the present disclosure include at least: (1) eliminating the need for additional hardware, (2) ensuring all images remain inside the household, with no cloud storage or third party examining in-home images, and (3) reducing bandwidth costs and load (that would be associated with communicating and storing images in the cloud).

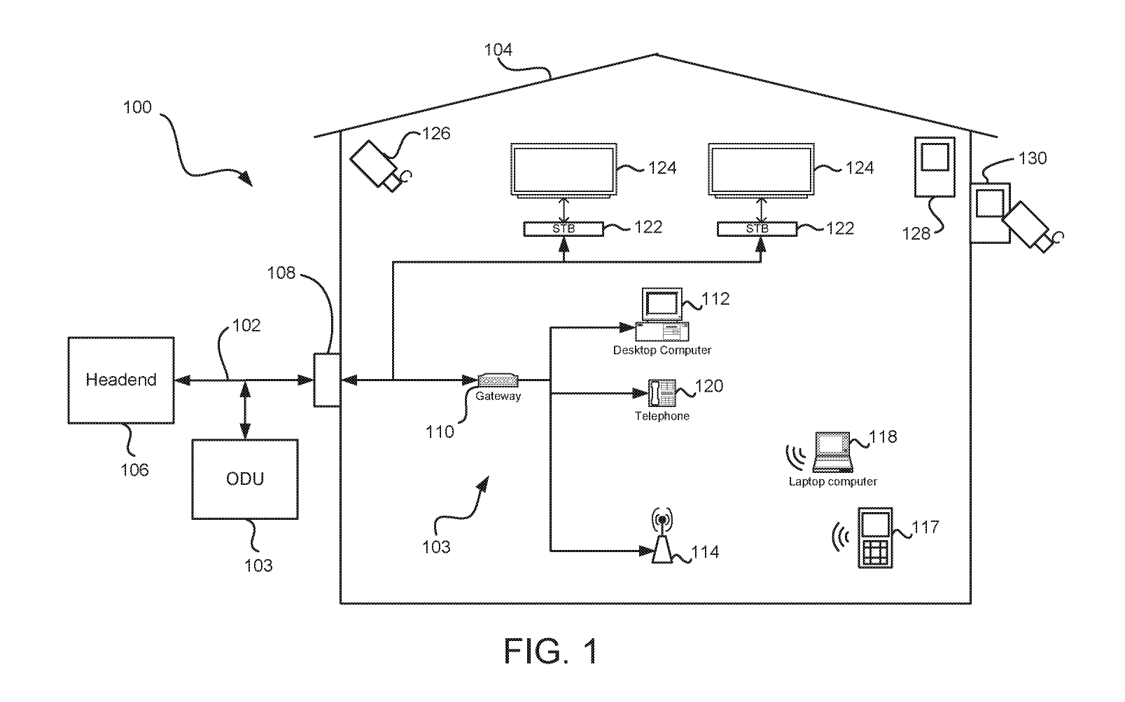

Turning to FIG. 1, an example information distribution network 100 is illustrated. Network 100 may be any type of information distribution network, such as satellite, telephone, cellular, wireless network, etc. The example illustrated may be a hybrid fiber/coax distribution network found in many cable television networks. Such networks 100, use a series of interconnected transmission lines 102, such as coaxial cables fiber optic cables, or any other desired transmission medium, to connect multiple homes 104 to a central office or headend 106 and/or an outdoor unit (ODU) 103 which receives signals from satellites and from terrestrial transmission towers through an over the air and/or near earth orbit communications link. The ODU 103 and/or headend 106 may transmit downstream information signals onto the lines 102, and each home 104 may have a tuner used to receive and process those signals.

The headend 106 may include a server configured to handle communications with the homes 102 using whichever communication medium is available. For example, in a coaxial cable or hybrid fiber/coax system, the headend 106 may include a modem termination system (MTS), such as a cable modem termination system (CMTS), which may be a computing device configured to manage communications between devices on the network of lines 102 and backend devices such as content sources (e.g., video on demand servers, television program sources, etc.), headend computers and other networks. The CMTS may be as specified in the Data Over Cable Service Interface Specification (DOCSIS) standard, published by Cable Television Laboratories, Inc. (a.k.a. CableLabs), or it may be a similar or modified device instead. The CMTS may be configured to place data on one or more downstream frequencies to be received by modems or gateways at the various homes 102, and to receive upstream communications from those modems or gateways on one or more upstream frequencies, as well as to serve as an interface to devices and networks that are further upstream, such as other Internet devices. Similar types of headend systems may be used for other types of networks, such as an optical fiber termination system for optical media, telephone line DSLAM (Digital Subscriber Line Access Multiplexer) for telephone lines, satellite transceiver, cellular telephone station, local area wireless (e.g., WiMax), etc.

The home 104 may be connected to the network 100 via an interface 108. The transmission line (coaxial, fiber, etc.) may be connected to a home gateway device 110. The gateway device 110 may be a computing device configured to communicate over the network 100 and with the headend 106. The gateway 110 may include, for example, a modem configured to communicate with the termination system at the headend 106.

The gateway 110 may be connected to a variety of devices within the home forming a home network 103, and may coordinate communications among those devices, and between the devices and networks outside the home 104. For example, the gateway 110 may include a modem (e.g., a DOCSIS device communicating with CMTS), and may offer Internet connectivity to one or more computers 112 within the home. The connectivity may also be extended to one or more wireless routers 114. For example, router 114 may be an IEEE 802.11 router, local cordless telephone (e.g., Digital Enhanced Cordless Telephone—DECT), or any other desired type of wireless network. Various wireless devices within the home, such as a DECT phone 117 (or a DECT interface within a cordless telephone), portable laptop computer 118, image/video capturing devices 126, motion sensors/detectors 128, combination camera/motion sensors 130, may communicate with the gateway 110 using wireless router 114. It is to be appreciated that the router may be integrated into the gateway 110 eliminating the need for a separate router 114.

The gateway 110 may also include one or more telephone interfaces, to allow the gateway 110 to communicate with one or more telephones 120. Telephones 120 may be a traditional analog twisted pair telephone (in which case the gateway 110 may include a twisted pair interface), or it may be a digital telephone such as a Voice Over Internet Protocol (VoIP) telephone, in which case the phone 120 may simply communicate with the gateway 110 using a digital interface, such as an Ethernet interface.

The incoming line 102 may also be connected to one or more network interface devices 122, which can be set-top boxes (STBs), digital video recorders (DVRs), etc. The STBs 122 may receive and decode content via the line (e.g., optical, coaxial, etc.), and may provide that content to users for consumption, such as for viewing video content on a television 124. Alternatively, televisions, or other viewing devices 124, may be connected to transmission line 102 directly without a STB, and may perform the functions of a STB. Any type of content, such as video, video on demand, audio, Internet data etc., can be accessed in this manner. As an alternative, the STB functionality can be incorporated with the gateway, so that the gateway 110 receives and decodes content from the line, and supplies it to the televisions for display using any desired local home physical interface.

The gateway 110 may communicate with the various devices within the home using any desired connection and protocol. For example, an in-home MoCA (Multimedia Over Coax Alliance) network may use a home's internal coaxial cable network to distribute signals to the various devices in the homes. Alternatively, some or all of the connections may be of a variety of formats (e.g., MoCA, Ethernet, HDMI, DVI, twisted pair, etc.), depending on the particular end device being used. The connections may also be implemented wirelessly, using local Wi-Fi, WiMax, Bluetooth, or any other desired wireless format.

It is to be appreciated that the devices in the home/premises may be a smart device, i.e., an electronic device generally connected to other devices or networks via different wired and/or wireless protocols. For example, the smart device may be a smart appliance, such as, but not limited to, a smart stove, smart thermostat, smart refrigerator, smart washing machine, smart television, smart phone, smart gateway, smart set-top box, etc. It is to be appreciated that the smart devices may be configured to communicate with each other in a variety of ways. For example, in some embodiments, each of the smart devices may be configured to communicate via wireless and/or radio frequency communication, such as, but not limited to, Wi-Fi, Bluetooth, Transmission Control Protocol/Internet Protocol, Secure Shell, File Transfer Protocol, ZigBee, Z-Wave, Mobile Communication Protocols (e.g., 2G, 3G, 4G, LTE, etc.), NFC, Radio Frequency Identification (RFID), and any other protocols suitable to support the Internet of Things. Furthermore, each smart device may be coupled to a power line of the home/premises and may be configured to communicate via the power line using one or more narrowband and/or broadband power line communication protocols, such as, but not limited to, Universal Powerline Bus, X10, Ethernet Over Power (e.g., HomePlug AV, Powerline AV, etc.), and any other protocols suitable to support power line communication.

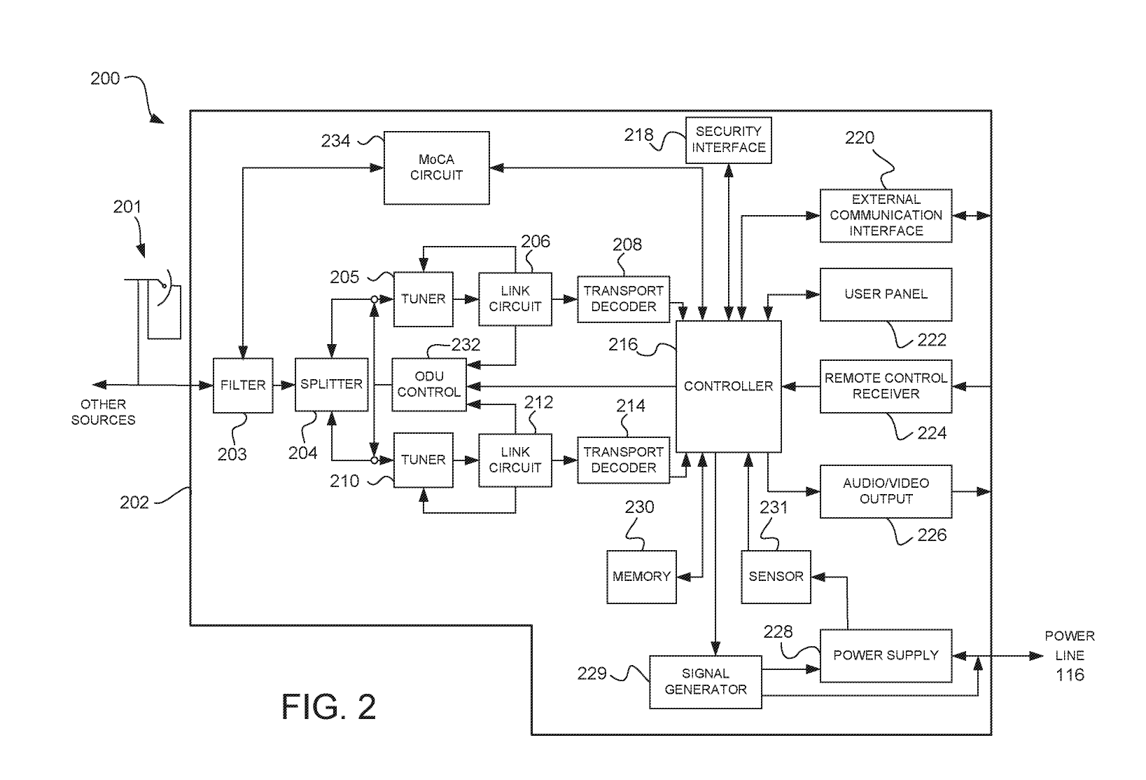

Referring to FIG. 2, the source device 202 will be described as a set-top box that is part of a signal receiving system 200. The signal receiving system 200 receives signals, e.g., media content, Internet communications, etc., over one of several possible networks including, but not limited to, over the air, cable, satellite, Ethernet, fiber and phone line networks. For example, the signals may be received via an outdoor unit (ODU) 201 and/or other sources, such as, but not limited to a headend, such as, headend 106 and provided to set-top box 202. Although system 200 and set-top box are configured to receive signals from a plurality of sources, in the embodiment described below, system 200 and set-top box 202 is described primarily as receiving signals from one or more satellites as well as multiple television broadcast transmission sites. The signals are provided by one or more service providers and represent broadcast audio and video programs and content. System 200 is described as including components that reside both inside and outside a user's premises. It is important to note that one or more components in system 200 may be moved from inside to outside a premises, such as, dwelling or building 100. Further, one or more components may be integrated with a display device, such as a television or display monitor (not shown). In either case, several components and interconnections necessary for complete operation of system 200 are not shown in the interest of conciseness, as the components not shown are well known to those skilled in the art.

ODU 201 receives signals from satellites and from terrestrial transmission towers through an over the air and/or near earth orbit communications link. ODU 201 is connected to set-top box 202. In one embodiment, ODU 201 may further be coupled to dwelling or building 100. Within set-top box 202, the input is connected to filter 203. Optionally, filter 203 can be connected to splitter 204. Filter 203 is coupled to three signal processing paths. A first path includes tuner 205, link circuit 206, and transport decoder 208 connected together serially. A second path includes tuner 210, link circuit 212, and transport decoder 214 connected together serially. A third path includes MoCA circuit 234 which further connects to controller 216. The outputs of transport decoder 208 and transport decoder 214 each connect to controller or processor 216. Controller 216 connects to security interface 218, external communication interface 220, user panel 222, remote control receiver 224, audio/video output 226, power supply 228, memory 230, and ODU control 232. External communication interface 220, remote control receiver 224, audio/video output 226, and power supply 228 provide external interfaces for the set-top box 202. ODU control 232 also connects to the filter 203.

Satellite signal streams, each containing a plurality of channels, are received by ODU 201. ODU 201 includes a dish for capturing and focusing the propagated radio wave from the atmosphere onto one or more antennas contained within a structure known as a low noise block converter (LNB). ODU 201 may be configured to receive the signal streams from satellite transponders located on one or more satellites. In one embodiment, two sets of sixteen channels are received by ODU 201, and converted, using one or more LNBs to a frequency range of 950 Megahertz (MHz) to 2,150 MHz, referred to as L-band. ODU 201 also includes a terrestrial antenna for receiving over the air broadcasts. In one embodiment, ODU 201 includes a multiple element antenna array for receiving ISDB-T signals in the frequency range from 170 MHz to 800 MHz.

ODU 201 provides a converted signal stream to the set-top box 202 through radio frequency (RF) co-axial cable. The converted signal stream is provided to filter 203. In one embodiment, filter 203 operates as a multiplex filter with up to three separate filter sections or interfaces. The frequency response properties of filter 203 may include a separate highpass filter and lowpass filter such that the frequency passbands of each do not overlap. The arrangement, often referred to as a diplexer or diplex filter, allows for a separation, through signal filtering, of the incoming satellite signal and/or MoCA signal from the terrestrial signal and/or MoCA signal. In one embodiment, the low pass filter frequency response pass band ends at a frequency below 900 MHz. The low pass filter portion allows a MoCA signal in a frequency range from 475 MHz to 625 MHz as well as a terrestrial signal in the frequency range from 170 MHz to 800 MHz to pass through to subsequent blocks while attenuating, or not passing through, a satellite signal in a frequency range from 950 MHz to 2,150 MHz. The high pass filter portion operates in an opposite manner passing the MoCA signal, in the frequency range around 1100 MHz, along with the satellite signal through and attenuating cable or terrestrial broadcast signal. The high pass filter portion may also filter any electrical supply or communication signals provided to the ODU 201. An additional bandpass filter circuit may be provided to further process MoCA signals and provide the signals as an output to a home MoCA network or for processing in set-top box 202. Other embodiments may be possible and some of these embodiments are described in further detail below. Filter 203 may also include surge or transient voltage protection devices.

The output signal from the high pass filter portion of filter 203 is provided to a first signal path containing a tuner 205, a link circuit 206, and a transport decoder 208 connected in a serial fashion. The output signal from the low pass filter portion of the filter 203 is provided to a second signal path. The second signal path also contains a tuner 210, a link circuit 212, and a transport decoder 214 connected in a serial fashion. Each processing path may perform similar processing on the filtered signal streams, the processing being specific to the transmission protocol used.

Tuner 205 processes the split signal stream by selecting or tuning one of the channels provided from a satellite service provider in the highpass filtered signal stream to produce one or more baseband signals. Tuner 205 contains circuits (e.g., amplifiers, filters, mixers, and oscillators) for amplifying, filtering and frequency converting the satellite signal stream. Tuner 205 typically is controlled or adjusted by link circuit 206. Alternately, tuner 205 may be controlled by another controller, such as controller 216, which will be described later. The control commands include commands for changing the frequency of an oscillator used with a mixer in tuner 205 to perform the frequency conversion.

Tuner 210 processes the lowpass filtered signal stream by selecting or tuning one of the terrestrial or cable broadcast channels in the split signal stream to produce one or more baseband signals. Tuner 210 contains circuits (e.g., amplifiers, filters, mixers, and oscillators) for amplifying, filtering and frequency converting the signal stream. Tuner 210 may be controlled or adjusted in a manner similar to that described earlier for tuner 205.

Typically, the baseband signals at the output of tuner 205 or tuner 210 may collectively be referred to as the desired received signal and represent one satellite channel selected out of a group of channels that were received as the input signal stream. Although the signal is described as a baseband signal, this signal may actually be positioned at a frequency that is only near to baseband.

The one or more baseband signals from the satellite service provider are provided to link circuit 206 through tuner 205. Link circuit 206 typically contains the processing circuits needed to convert the one or more baseband signals into a digital signal for demodulation by the remaining circuitry of link circuit 206. In one embodiment, the digital signal may represent a digital version of the one or more baseband signals. In another embodiment, the digital signal may represent the vector form of the one or more baseband signals. Link circuit 206 also demodulates and performs error correction on the digital signal from the satellite service provider to produce a transport signal. The transport signal may represent a data stream for one program, often referred to as a single program transport streams (SPTS), or it may represent multiple program streams multiplexed together, referred to as a multiple program transport stream (MPTS).

The one or more baseband signals from the broadcast service provider are provided to link circuit 212 through tuner 210. Link circuit 212 typically contains the processing circuits needed to convert the one or more baseband signals into a digital signal for demodulation by the remaining circuitry of link circuit 212 in a manner similar to link circuit 206 described earlier. Link circuit 212 also demodulates, performs broadcast channel equalization error correction on the digital signal from the broadcast service provider to produce a transport signal. As described earlier, the transport signal may represent a data stream for one program or it may represent multiple program streams multiplexed together.

The transport signal from link circuit 206 is provided to transport decoder 208. Transport decoder 208 typically separates the transport signal, which is provided as either a SPTS or MPTS, into individual program streams and control signals. Transport decoder 208 also decodes the program streams, and creates audio and video signals from these decoded program streams. In one embodiment, transport decoder 208 is directed by user inputs or through a controller such as controller 216 to decode only the one program stream that has been selected by a user and create only one audio and video signal corresponding to this one decoded program stream. In another embodiment, transport decoder 208 may be directed to decode all of the available program streams and then create one more audio and video signals depending on user request.

The transport signal from link circuit 212 is similarly provided to transport decoder 214. Transport decoder 214 decodes the program streams, and creates audio and video signals from these decoded program streams as directed by user inputs or a controller in a manner similar to that described earlier for transport decoder 208.

The audio and video signals, along with any necessary control signals, from both transport decoder 208 and transport decoder 214 are provided to controller 216. Controller 216 manages the routing and interfacing of the audio, video, and control signals and, further, controls various functions within set-top box 202. For example, the audio and video signals from transport decoder 208 may be routed through controller 216 to an audio/video (A/V) output 226. A/V output 226 supplies the audio and video signals from set-top box 202 for use by external devices (e.g., televisions, display monitors, and computers). Also, the audio and video signals from transport decoder 214 may be routed through controller 216 to memory block 230 for recording and storage.

Memory block 230 may contain several forms of memory including one or more large capacity integrated electronic memories, such as static random access memory (SRAM), dynamic RAM (DRAM), or hard storage media, such as a hard disk drive or an interchangeable optical disk storage system (e.g., compact disk drive or digital video disk drive). Memory block 230 may include a memory section for storage of instructions and data used by controller 216 as well as a memory section for audio and video signal storage. Controller 216 may also allow storage of signals in memory block 230 in an alternate form (e.g., an MPTS or SPTS from transport decoder 208 or transport decoder 214).

Controller 216 is also connected to an external communications interface 220. External communication interface 220 may provide signals for establishing billing and use of the service provider content. External communications interface 220 may include a phone modem for providing phone connection to a service provider. External communications interface 220 may also include an interface for connection to an Ethernet network and/or to home wireless communications network. The Ethernet network and/or home wireless network may be used for communication data, audio, and/or video signals and content to and from other devices connected to the Ethernet network and/or home wireless network (e.g., other media devices in a home). In one embodiment, external communications interface 220 may be used to communicate with some or all of the devices coupled to power line 116 of dwelling or building 100 via the home wireless network of dwelling or building 100 using one or more of the wireless communication protocols described above (e.g., Wi-Fi, Bluetooth, ZigBee, Z-Wave, etc.).

Controller 216 also connects to a security interface 218 for communicating signals that manage and authorize use of the audio/video signals and for preventing unauthorized use. Security interface 218 may include a removable security device, such as a smart card. User control is accomplished through user panel 222, for providing a direct input of user commands to control the set-top box and remote control receiver 224, for receiving commands from an external remote control device. Although not shown, controller 216 may also connect to the tuners 205, 210, link circuits 206, 212, and transport decoders 208, 214 to provide initialization and set-up information in addition to passing control information between the blocks.

Finally, power supply 228 typically connects to all of the blocks in set-top box 202 and supplies the power to those blocks as well as providing power to any of the elements needing power externally, such as the ODU 201. In one embodiment, power supply 228 is coupled to power line 116 of dwelling or building 100, via, for example, a multi-conductor cord and plug. Power supply 228 may also be coupled to a signal generator 229 and a sensor 231, where signal generator 229 and sensor 231 may each be further coupled to controller 216. The signal generator 229 and sensor 231 will be described in greater detail below.

Controller 216 also controls ODU control 232. ODU control 232 provides signaling and power supply electrical power back to the ODU 201 through filter 203. ODU control 232 provides these signals and power onto the co-axial cable(s) running between ODU 201 and set-top box 202. In one embodiment, the ODU control 232 receives input control signals from controller 216 and provides different DC voltage levels to specific portions of the ODU 201 to provide a certain signal stream containing a set of programs or content to filter 203 and further to tuner 205 and tuner 210. In another embodiment, the ODU control 232 receives inputs from controller 216 and also from link circuit 206 and link circuit 212 and provides DC voltage levels and a separate tuning control signal to ODU 201 using low frequency carrier based frequency shift keying modulation or using SWM format. Controller 216 also may send control commands to disable ODU controller 230 from providing either direct current (DC) voltages or control signals to ODU 201.

MoCA circuit 234 amplifies and processes the MoCA signal both for reception and transmission. As described above the MoCA interface permits communications of audio and video signals in a home network and may operate bi-directionally. MoCA circuit 234 includes a low noise amplifier for improving reception performance of a MoCA signal received by signal receiving device 200 from another network connected device. The received and amplified signal is tuned, demodulated, and decoded. The decoded signal may be provided to a number of other circuits, including audio and video outputs as well as a mass storage device (e.g., hard disk drive, optical drive, and the like), not shown. Additionally, MoCA circuit 234 generates and formats the MoCA transmit signal using audio and video content available in signal receiving device, including content received from the input (e.g., satellite signal) and content from the mass storage device. MoCA circuit 234 also includes a power amplifier for increasing the transmitted signal level of the MoCA signal sent by system 200 to another network connected device. Adjustment of the receive signal amplification as well as the transmit signal amplification in MoCA circuit 234 may be controlled by controller 216.

It should be appreciated by one skilled in the art that the blocks described inside set-top box 202 have important interrelations, and some blocks may be combined and/or rearranged and still provide the same basic overall functionality. For example, transport decoder 208 and transport decoder 214 may be combined and further integrated along with some or all of the functions of controller 216 into a System on a Chip (SoC) that operates as the main controller for set-top box 202. Further, control of various functions may be distributed or allocated based on specific design applications and requirements. As an example, link circuit 206 may provide control signals to ODU control 232 and no connection may exist between link circuit 212 and ODU control 232.

Further, it should be appreciated although ODU 201 includes both a dish and LNB for use with satellite signals and a terrestrial antenna, other embodiments may use separate structures. In some embodiments, the satellite dish and LNB and included in one structure and the terrestrial antenna is part of a second structure. The outputs of both satellite dish/LNB structure and terrestrial antenna are combined using a signal combining circuit and provided to set-top box 202.

Although set-top box 202 is described above as receiving a single converted signal stream, set-top box 202 may also be configured to receive two or more separate converted signal streams supplied by ODU 201 in some modes of operation. Operation in these modes may include additional components including switches and/or further tuning and signal receiving components, not shown. Further, set-top box 202 may be designed to operate only on a home network using the Ethernet or home wireless network interfaces described above. In this case, the elements associated with operation in a MoCA network may be removed from set-top box 202.

As shown in FIG. 2, power supply 228 is coupled to power line 116, signal generator 229, and sensor 231. Power supply 228 receives the power mains signal from power line 116 (e.g., via an outlet or other component connected to power line 116, such as cameras 126, 130, and/or motion detector 128) and provides the power mains signal to sensor 231. Sensor 231 is configured to measure one or more electrical parameters (e.g., voltage, current, frequency, etc.) associated with the power mains signal. In one embodiment, sensor 231 includes an analog to digital converter to convert the measured electrical parameters associated with the power mains signal into a digital signal that is provided to controller or processor 216. It is to be appreciated that, in some embodiments, sensor 231 may be directly coupled to power line 116 instead of being coupled to power supply 228.

In one embodiment, set-top box 202 is configured to send and receive power line communication signals to and from other devices coupled to power line 116, such as cameras 126, 130, and/or motion detector 128. The signals may include information associated with one or more images/video streams captures by cameras 126, 130, or motion detected via motion detector 128 and/or camera 130. For example, power line communication signals may be received by set-top box 202 via power supply 228 and provided to sensor 231, where sensor 231 is configured to measure, or sense, the power line communication signals and convert them to digital signals that are provided to controller 216. Controller 216 is further configured to process and read the digital power line communication signals. Furthermore, controller 216 may generate and transmit power line communication signals via signal generator 229. In one embodiment, signal generator 229 is configured to generate power signals in response to a control signal from controller 216, and signal generator 229 is configured to provide the generated power signals to power line 116 (either directly or via power supply 228). The generated power signals may then be received by one or more of the devices coupled to power line 116.

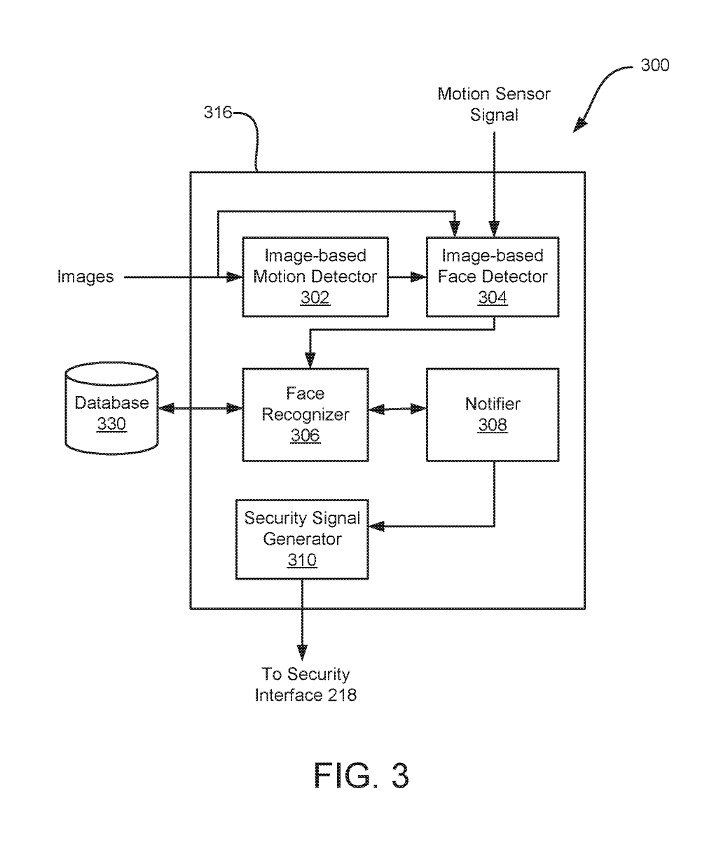

Turning to FIG. 3 an exemplary system 300 is shown in accordance with the present disclosure. System 300 includes controller 316 that receives at least one image or a video stream, detects a face in the at least one image or video stream and compares the detected face to a database 330 of known faces. The database 330 includes stored images of all known and approved faces that have been seen in this household or building. If the detected face matches a known face, the controller 316 may ignore the detected face or trigger a notification or an alert to a user. If the detected face does not match a known face, the controller 316 transmits a notification or alert to a user for further action. As seen in FIG. 3, controller 316 includes image-based motion detector 302, image-based face detector 304, face recognizer 306, notifier 308, and security signal generator 310.

It is to be appreciated that controller 316 may be a controller in any of the network connected devices described above. For example, controller 316 may be the same as controller 216. Alternatively, controller 316 may be a controller in set-top box 122, gateway 110, or any smart and/or network connected computing device that is existing in a dwelling or building, such as home 104. Also, it is to be appreciated that controller 316 is configured to receive information (e.g., images, video streams, motion sensor signals, etc.) and send information to/from any of the devices described above (e.g., smart devices, network connected computing devices, cameras 126, 130, motion detection 126, etc.) via any of the communication protocols described above (e.g., including wireless, wired, and/or powerline communication protocols).

Image-based motion detector 302 receives at least one image or a video stream, for example, from a camera or an array of cameras disposed around the home, e.g., camera 126, camera 130. The cameras 126, 130 may be located in the home targeting one or more relevant areas, such as, but not limited to, a living room, garage, front door, etc. In one embodiment, the image-based motion detector 302 detects motion or a moving object in the at least one video using various image processing techniques. For example, in one embodiment, motion is detected by comparing a current image or frame of a video to a previous image or frame of the video to determine if there is an energy difference above a predetermined threshold between the current image and the previous image. Once motion is detected, the at least one image is transmitted to the image-based face detector 304. In an alternate embodiment, analysis of the at least one image by the image-based face detector 304 may be triggered by a signal from the motion detector 128, e.g., an inductive motion sensor, infrared motion sensor, etc.

In either case, the image-based face detector 304 analyzes the at least one image, e.g., a frame of a video, to detect a face(s). It is to be appreciated that the face detection may be performed using off-the-shelf open source software, such as OpenCV or deep learning approaches using Tensorflow™ or other deep learning software. If a face is detected by the image-based face detector 304, the at least one image, or a portion of the image including the detected face, is transmitted to the face recognizer 306. Face recognizer 306 employs facial recognition algorithms or functions to compare the detected face to known faces previously stored in database 330. From the detected faces, using image processing techniques to preprocess (e.g., histogram normalization, equalization, resize/shape face etc.), the face recognizer 306 compares the detected face against the stored database of known faces from this household. Facial recognition may be performed using known techniques like Eigenfaces or Fisherfaces.

In one embodiment, if the face recognizer 306 determines that the detected face matches a known face, the controller 316 may ignore the detected face and take no further action. In another embodiment, the controller 316 may trigger a notification to be sent to a relevant entity via notifier 308 if a match is found. The controller 316 may be preprogrammed with rules depending on which known face is matched. For example, if the known face is of a child residing at the home, the controller 316 may trigger the notifier 308 to send a notification to a parent of the home that the child has arrived. The notifier 308 may send the notification via the audio/video output 226 to a display device (such as TV 124), via the external communication interface 220 to a phone or other device in the home (such as phone 117, laptop 118, etc.) or a mobile phone or device outside the home.

If the face recognizer 306 determines that the detected face does not match a known face in the database 330, the controller 316 may trigger the notifier 308 to send a notification to a user via at least one second device, e.g., a display device 124 coupled to a set-top box 122, a phone 117, etc. The notification may prompt the user to approve or disapproved of the detected face. If the user approves of the detected face, e.g., via an input to the set-top box, phone, etc., the controller 316 may add the detected face to the database of known faces. If the user disapproves of the detected face, upon receipt of the disapproval signal at the controller 316, the notifier 308 may trigger the security signal generator 310 to generate a signal to issue a security warning. In one embodiment, the security warning signal is transmitted through the security interface 218 to a security system in the home which may subsequently contact the proper authority. In another embodiment, the security warning signal may trigger an audio device located in the home.

It is to be appreciated that the controller 316 of the present disclosure may be implemented in hardware, software, firmware, or any combinations thereof. In some embodiments, the controller 316 may be implemented in software or firmware that is stored on a memory device (e.g., a memory device) and that is executable by a suitable instruction execution system (e.g., a processing device). In some embodiments, the various modules (e.g., module 302, 304, 306, 308, 310) may be implemented in hardware using, for example, discrete logic circuitry, an application specific integrated circuit (ASIC), a programmable gate array (PGA), a field programmable gate array (FPGA), or any combinations thereof. It is to be further appreciated that the various functions described above in relation to the various modules may be performed on a device, such as a set-top box, not specifically designed for this activity but using its dormant computing ability, for example, while the set-top box is streaming high definition (HD) video, the various functions can be performed in the background.

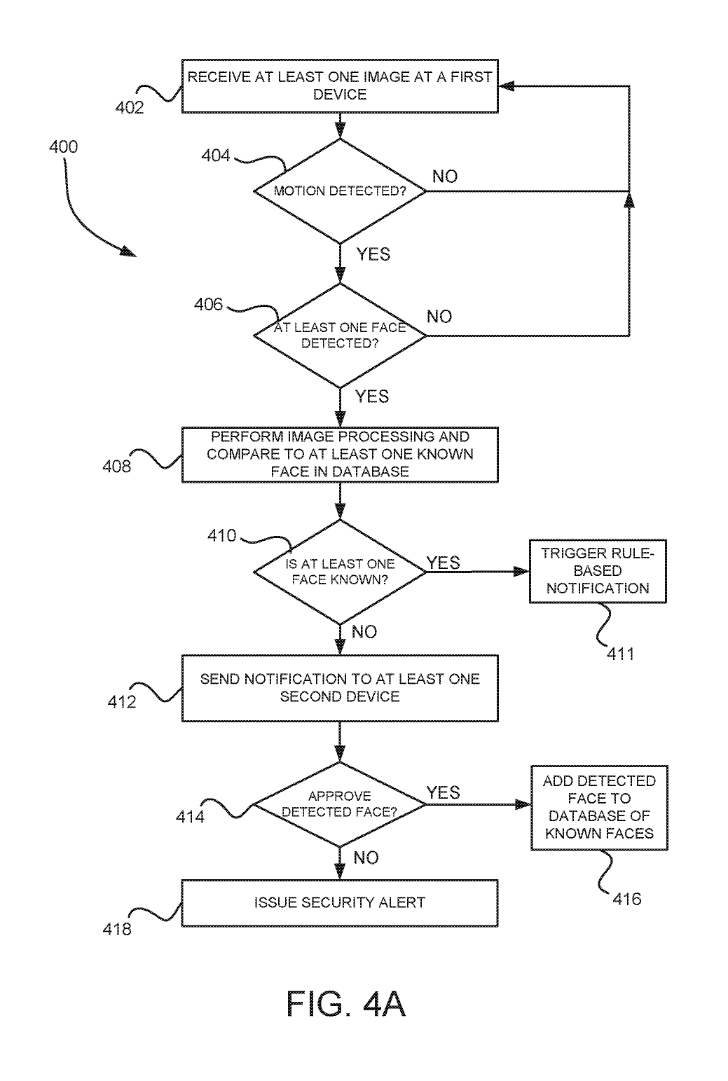

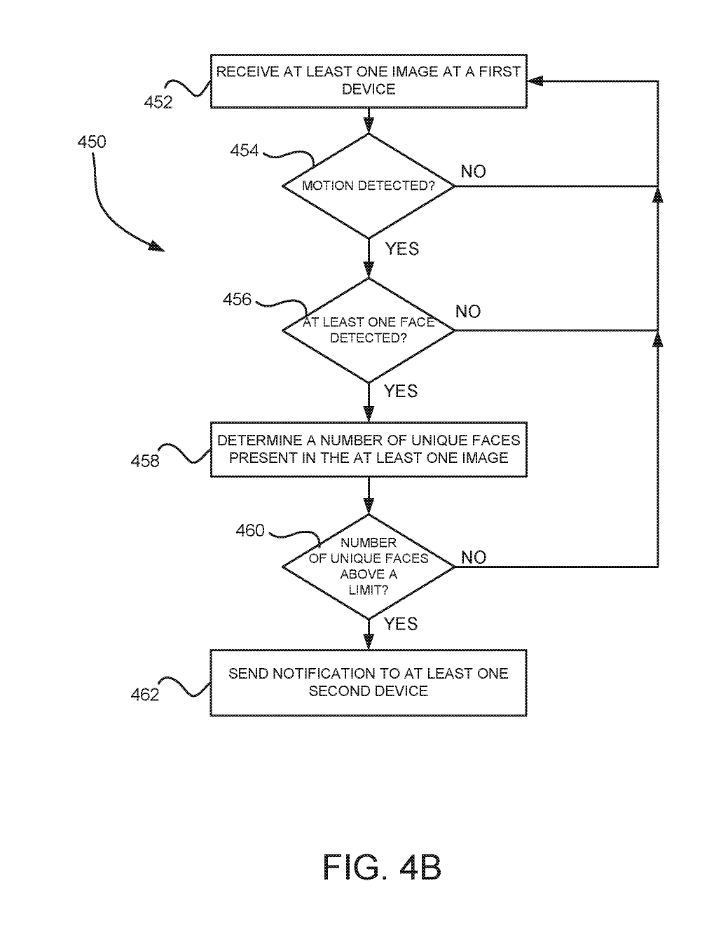

Referring to FIG. 4A, a flowchart of an exemplary method 400 for providing privacy-preserving security to a dwelling or building is shown in accordance with the present disclosure. It is to be appreciated that the method 400 may be used with any one of gateway 110, set-top box 112, set-top box 202 and/or system 300, described above.

In step 402, image-based motion detector 302 receives at least one image or a video stream at a first device, for example, from a camera or an array of cameras disposed around the home, e.g., camera 126, camera 130. The image-based motion detector 302 detects motion or a moving object in the at least one image using various image processing techniques, at step 404. If the image-based motion detector 302 does not detect motion in the at least one image, the method reverts to step 402 to await further images. If at step 404, motion is detected, the at least one image is transmitted to the image-based face detector 304. In an alternate embodiment, analysis of the at least one image by the image-based face detector may be triggered by a signal from the motion detector 128. At step 406, the image-based face detector 304 analyzes the at least one image to detect a face(s). If a face is detected by the image-based face detector 304, at step 406, the at least one image or a portion of the image including the detected face is transmitted to the face recognizer 306. In step 408, the face recognizer 306 employs facial recognition algorithms or functions to compare the detected face to known faces previously stored in database 330.

In step 410, if the face recognizer 306 determines that the detected face matches a known face, the controller 316 may ignore the detected face and take no further action and revert to step 402. If, in step 410, the controller 316 determines that the detected face matches a known face, the controller 316 may trigger a notification, at step 411. The controller 316 may be preprogrammed with rules depending on which known face is matched. If, in step 410, the face recognizer 306 determines that the detected face does not match a known face in the database 330, the controller 316 may trigger the notifier 308 to send a notification to a user via at least one second device, e.g., a display device 124 coupled to a set-top box 122, a phone 117, etc., in step 412. The notification may prompt the user to approve or disapprove of the detected face. For example, in one embodiment, the notification is a text message and includes the image of the detected face or a portion thereof, with the prompt for the user to approve or disapprove. If, in step 414, the user approves of the detected face, e.g., via an input to the set-top box, phone, etc., the controller 316 may add the detected face to the database of known faces, in step 416. If the user disapproves of the detected face, in step 414, upon receipt of the disapproval signal at the controller 316, the notifier 308 may trigger the security signal generator 310 to generate a signal to issue a security warning, in step 418, e.g., when the image indicates that a stranger is in the home. In one embodiment, the security warning signal is transmitted through the security interface 218 to a security system in the home which may subsequently contact the proper authority. In another embodiment, the security warning signal may trigger an audio device located in the home.

The privacy-preserving security system 300 of the present disclosure may also be used to determine, at any given time, or for a period of time, how many people are present in a home or dwelling or in the environment surrounding the home or dwelling (e.g., on the porch, in the yard, etc.) and trigger one or more rules and/or notifications based on if the number of people present in or around the home is above a predetermined threshold or limit set by the user. This feature of system 300 may be useful for monitoring children and teenagers in or around a home while parents and/or other responsible parties are absent from the home or in a portion of the home (e.g., the bedroom, yard, etc.) remote to where the children and or teenagers are located (e.g., the living room, basement, etc.) As with the above-described embodiments, existing computing and image/video capturing devices (e.g., cameras 126, 130) within and around a home are leveraged to monitor the number of people present in or around the house. If the system detects that more than a specified number of people are present in the home (e.g., a parent states that a child can have two friends over, however, the child brings six friends), a notification will be sent to a relevant party (e.g., the parent) including the number of people currently in the home. Since, existing, dormant computing power is used to implement this feature, all processing is done entirely on-premise (e.g., using a controller of a set-top box, such as set-top box 112, set-top box 202, and/or system 300), within no image and/or other private data sent to the cloud (i.e., a network outside the home). This creates a completely private monitoring system, where only the notification containing the number of people in the house is sent to the cloud.

Referring to FIG. 3, one or more images (e.g., from one or more camera and/or video sources) are provided to image-based motion detector 302 and/or image-based face detector 304. The one or more images may be a plurality of image frames from video captures from cameras, such as, cameras 126, 130. The images are aggregated and image-based motion detector 302 and/or image-based face detector 304 are used to identify candidate images among the aggregated images to detect faces from. For example, in one embodiment, candidate images are identified by image-based motion detector 302 by comparing a previous candidate image (i.e., an image already evaluated by image-based motion detector) to a current image to detect motion. In one embodiment, motion is detected in a currently evaluated image by determining if an energy difference is present between the current image and the previous image. If the energy difference is above a predetermined threshold, the current image is retained as a candidate image. In another embodiment, to reduce the computational load on controller 316, image-based face detector 304 is configured to only evaluate every Nth frame (e.g., every 10th frame) of a stream of images received and aggregated to detect faces, since face detection only requires relatively low processing power. If at least one face is detected in the Nth frame, the at least one frame or image is identified and retained as a candidate image. In this way, using motion detection and/or face detection the number of images or frames that are evaluated to determine the number of people present in the home is decreased to reduce computation load on controller 316. In an alternate embodiment, analysis of the one or more images by the image-based face detector may be triggered by a signal from the motion detector 128.

It is to be appreciated that the images and/or videos from cameras 126, 130 may be provided to controller 316 at predetermined time intervals (e.g., every 5 minutes). Furthermore, it is to be appreciated that images and/or videos from cameras 126, 130 may be aggregated throughout the time intervals. For example, if the time interval the images and/or videos are sent from cameras 126, 130, is 5 minutes, all of the images and/or videos accumulated from cameras 126, 130 are sent to controller 316 for analysis.

Candidate images or frames identified are analyzed by image-based face detector 304 and face recognizer 306 to determine a number of unique faces present in the candidate images. In one embodiments, face detector 304 detects all faces within all candidate images. Then, all of the detected faces are provided to face recognizer 306. Face recognizer 306 is configured to compare all of the faces in the candidate images against each other to determine if any faces appear more than once to identify any duplicates where the same person is captured in multiple images or frames. Any duplicate faces are discarded and only the number of unique faces are counted by face recognizer 306. This ensures that the same face is not counted twice.

Controller 316 then determines if the number of unique faces in or around the house are above a limit or threshold set by a user. It is to be appreciated that the limit may be configured to change depending on the time of the day. For example, during a time period designated as a “study session” (e.g., 3 PM to 5 PM), controller 316 may be configured to check if the number of unique faces in or around the house is above a first limit (e.g., ten people may only be present during the study session). After the “study session”, controller 316 may be configured to check if the number of unique faces in or around the house is above a second limit (e.g., only two people may be present after the study session) associated with another time period. It is to be appreciated that the time and length of the time period and the limit is selectable by the user. In some embodiments, different time periods and limits may be set for different rooms or locations of a home. For example, where cameras are available in each room or location of a home, restrictions may be set as to the number of people present during a time period within that room or location in the home. Different limits/time periods may be enforced concurrently by controller 316 for different rooms/locations in the home.

If controller 316 determines that the number of unique faces is above a limit or threshold set by the user, notifier 308 sends an alert or notification to the relevant user (e.g., a parent or other responsible party). The notification may include the number of people present in or around the home and one or more images or videos showing the people present in or around the home. The notification may be a text message or push notification sent to the relevant user's mobile phone, an email, or an automated phone call reciting the number of people present in or around the home. The notification may further be provided to a display device (e.g., a TV, such as TV 124) controller 316 is coupled to.

It is to be appreciated the text message, push notification, and/or automated phone call are generated by controller 316. The notification may include one or more prompts for responses or possible actions to take. For example, the notification may include a selectable prompt to set off an alarm signal in the home. If this prompt is selected by the user, security signal generator 310 of controller 316 is configured to output a security signal to interface 218 (e.g., causing an audible alarm to sound within the home). As another example, where the notification is an automated phone call, the automated phone call may include a voice recognition prompt that allows the relevant party to decide on a specified response to the number of people in or around the home being above the limit. The voice recognition prompt may listen for yes/no answers of the relevant party to one or more questions enabling the relevant party to decide on a specified response. For example, the specified response may be to call the child's mobile phone, to set off an alarm in the house, etc.

Referring to FIG. 4B, a flowchart of an exemplary method 450 for determining a number of unique faces present in or around a premises is shown in accordance with the present disclosure. It is to be appreciated that the method 400 may be used with any one of gateway 110, set-top box 112, set-top box 202 and/or system 300, described above.

In step 452, image-based motion detector 302 receives at least one image or one or more video streams at a first device, for example, from a camera or an array of cameras disposed around the home, e.g., camera 126, camera 130, that record the in-home (or surrounding, e.g., front porch, back yard) environment. The image-based motion detector 302 detects motion or a moving object in the at least one image using various image processing techniques, at step 454. If the image-based motion detector 302 does not detect motion in the at least one image, the method reverts to step 452 to await further images. If at step 454, motion is detected, the at least one image is transmitted to the image-based face detector 304. In an alternate embodiment, analysis of the at least one image by the image-based face detector 304 may be triggered by a signal from the motion detector 128. In yet another embodiment, image-based face detector 304 may analyze the at least one image independently from image-based motion detector 302.

It is to be appreciated that if a video stream from one or more video cameras is received in step 404, the image-based detector 302 is configured to determine which image frames are candidate frames to detect faces from. For example, in one embodiments candidate frames are determined based on if image-based motion detector 302 detects any motion within a given image frame. If motion is detected in a given image frame, the image frame is a candidate image and the method 450 proceeds to step 456. Alternatively, if no motion is detected in a given image frame, the image frame is not considered an image frame and that image frame is discarded and not processed further.

At step 456, the image-based face detector 304 analyzes the at least one image to detect one or more faces. If the image-based face detector 304 determines that at least one face is not detected in the at least one image, in step 452, the method reverts back to step 452. If one or more faces is detected by the image-based face detector 304, at step 456, the at least one image or a portion of the image including the detected face is transmitted to the face recognizer 306. In step 458, the face recognizer 306 employs facial recognition algorithms or functions to compare the detected faces to determine a number of unique faces present in the at least one image. In step 460, controller 316 determines if the number of unique faces present in the at least one image is above a limit or threshold. If it is determined that the number of unique faces present in the at least one image is above a limit or threshold, the notifier 308 sends a notification to at least one second device, such as, a relevant party's mobile device, in step 462. If it is determined that the number of unique faces is below the limit or threshold, the method reverts back to step 452 to wait to receive another image.

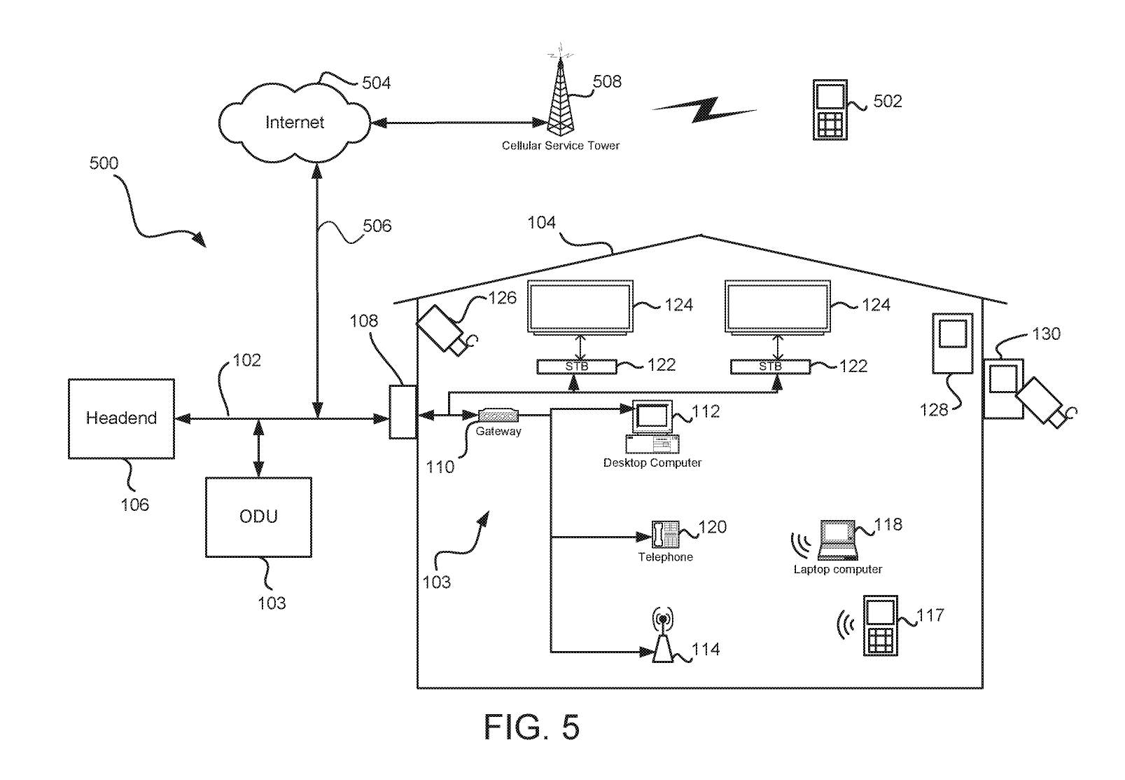

In another embodiment, the set-top box 122 (or another computing device employing the privacy-preserving security method and system described above) sends an alert or notification (for example, in executing steps 412 and/or 462 included in methods 400 and 450 above) to a device that is not directly connected to the home network 103, but coupled to the home network via other networks such as the Internet. In this embodiment, the set-top 122 is configured to send an alert to a mobile phone, e.g., a cellular phone, when the user is not at home. Referring to FIG. 5, an information distribution network 500 in accordance with another embodiment is illustrated. Network 500 is similar to network 100 shown in FIG. 1, therefore, similar components will not be described again in detail. In addition to the components shown in FIG. 1, network 500 includes the Internet 504, cellular service provider(s) 508, and mobile phone 502. In this embodiment, the set-top box 122 is configured to send an alert or notification message to a mobile phone 502 of a user or consumer associated to the home 104. The set-top 122 sends an alert message via a predetermined protocol, e.g., via SNMP (Simple Network Message Protocol) or TR-69 (also known as CPE WAN Management Protocol or CWMP) to a server coupled to the Internet 504. It is to be appreciated that the alert message may be sent to the server via transmission lines 102 and 506, via wired or wireless means, and/or the alert message may be sent to the server via the headend 106. The server then routes the message to an appropriate cellular service provider 508, which then relays the alert message to the mobile phone 502. The message to the mobile phone 502 may be in the form of a text message including alphanumeric characters or the at least one image or portion thereof. Other messaging systems employed by cellular service providers, such as e-mail, is contemplated to be within the scope of the present disclosure. In one embodiment, to ensure the at least one image is not transmitted over the Internet, only a text message is transmitted to the mobile phone 502. The text message may include a link to access a memory of the set-top box to view the at least one image without having to upload the at least one image.

It is to be appreciated that the alert messages can be configured remotely by an operator of the service provider or by the consumer. In one embodiment, a graphical user interface, e.g., a web page, is provided for the user to configure the alerts. In this embodiment, the user may configure rule-based triggers depending on a matched known face or a number of people present in or around the housing being above a limit. Additionally, the user may configure the notification or alert to be sent, e.g., record a voice message, upload graphics, etc., and/or configure a cell phone number to send SMS (Short Message Service) alerts to.

It is to be appreciated that the term “premises” as used herein means any land owned by one or more persons or business entities and any houses, dwellings, buildings, and/or structures disposed on the land. In this way, monitoring and providing security to a premises includes monitoring activity and/or persons within the premises, which includes areas both inside and outside the houses, dwellings, buildings, and/or structures of the premises.

As stated above, the privacy-preserving security system of the present disclosure is configured to leverage dormant power of an existing computing device within a home or dwelling. For example, in one embodiment, a first percentage of the total processing power by controller 316 is being used to execute normal functions. Where controller 316 is in a set-top box, a first percentage (e.g., 65%) of the processing power of controller 316 is used for normal functions, such as, but not limited to, receiving media content from one or more sources, decoding the media content, outputting the media content for display, etc. A second or remaining percentage of the processing power of controller 316 is unused or dormant (e.g., 35%). Controller 316 is configured to use only this dormant power to provide the privacy-preserving security system described above in relation to system 300 and methods 400, 450. In one embodiment, the first percentage (i.e., for executing normal functions) and the second percentage (i.e., dormant or unused) of the processing power of controller 316 is predetermined and stored in a memory of controller 316 or a device controller 316 is disposed in. In another embodiment, the first and second percentage is determined by controller 316, such that, controller 316 only uses dormant processing power (i.e., the second percentage) to execute the functions necessary to provide the privacy-preserving security system described above. In either case, since only dormant processing power is being used by controller 316, the privacy-preserving security system described above can be used by an existing processing device in a home or dwelling without negatively impacting the performance of the existing processing device and without needing a second, dedicated processing device for providing the privacy-preserving security system.

In another embodiment of the present disclosure, the privacy-preserving security features described above in relation to methods 400, 450 may be executed in a distributed dormant computing scheme using the dormant processing power of one or more processing devices within a premises or outside of a premises. For example, if controller 316 or any other processor or controller (e.g., controller 216) of a device executing methods 400, 450, determines that the current dormant processing power is below a predetermined threshold, controller 316 may be configured to employ the dormant processing power of one or more other computing devices within the premises and/or outside the premises, to execute some or all of the steps of method 400, 450.

Dormant processing power, i.e., available or unused processor or system capability, may be determined by the operating system of a device or system, such as controller 316, gateway 110, and/or set-top boxes 122, 202. For example, the “Task Manager” function of a system based on the Windows™ operating system from Microsoft™ routinely and continuously monitors the processor and memory utilization of all functions and applications active in the device or system. The information gathered by a system function such as Task Manager may be compiled or processed by a processor or controller of a computing device, such as, gateway 110, and/or set-top boxes 122, 202, to determine available resources or dormant processing power which may include unused resources such as available processor bandwidth, available memory, etc. Thus, each device or processor in a network or environment, such as home 104, may assess its own unused or dormant compute power and assess when the available or dormant compute power exceeds a threshold. Also, one device, such as controller 316, gateway 110, and/or set-top boxes 122, 202, controlling a distributed dormant processing power environment, as described herein, may interrogate one or more other devices to obtain the dormant compute power assessment determined by the one or more other devices and use that information to manage a distributed dormant processing power environment, e.g., allocate processing tasks to one or more other devices based on their available or dormant compute power.

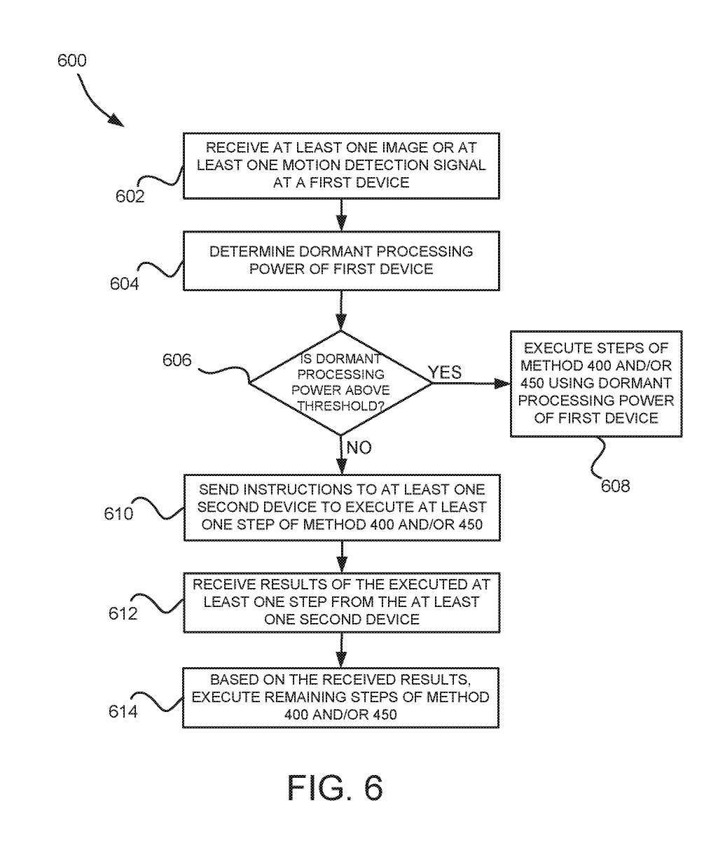

Referring to FIG. 6, a flowchart of an exemplary method 600 for providing a distributed dormant computing scheme to perform methods 400 and/or 500 is shown in accordance with the present disclosure. Method 600 is described below in reference to network 500 and home 104, however, it is to be appreciated that method 600 may be implemented using any of the devices and environments described above.

In step 602, a processor of a first computing device, e.g., controller 216, 316, gateway 110, set-top box 122, etc., receives at least one image (e.g., from an image/video capture sources, such as, cameras 126, 130) or at least one motion detection signal (e.g., from motion detector 128 and/or camera 130). As described above in relation to methods 400/450, the at least one image and/or motion detection signal is configured to trigger an analysis of at least one image to implement the privacy-preserving security features of methods 400 and/or 450. The processor of the first device in home 104 is configured to determine what the current dormant processing power of the first device is, in step 604, and if the processing power of the first device is above a predetermined threshold (e.g., above 30% dormant processing power), in step 606. It is to be appreciated that the threshold may be based on a maximum amount of processing power (e.g., determined via experiment and/or calculation) that is required to execute the steps of methods 400 and/or 450. In some embodiments, the threshold may be adjustable by the processor of the first device based on the number of images received for analysis, the size (e.g., in terms of memory used) of each image received, and/or which of methods 400 and/or 450 is to be executed.

If the processor of the first computing device determines that the dormant processing power is above the threshold, in step 606, the processor of the first computing device is configured to execute all of the steps of methods 400 and/or 450, in step 608. Alternatively, if the processor of the first computing device determines that the dormant processing power is not above the threshold, in step 606, the processor of the first computing device is configured to send instructions to at least one second device to execute at least one step of method 400 and/or 450.

For example, in performing step 610 of method 600, the processor of the first computing device may determine, based on the current dormant processing power of the first device, which and how many of the steps of methods 400 and/or 450 need to be performed using the dormant processing power of a second device. The processor of the first computing device may determine that all of the steps of methods 400 and/or 450 need to be performed using the dormant processing power of a second device. Alternatively, the processor of the first device may determine that only some of the steps of methods 400 and/or 450 need to be performed using the dormant processing power of a second device and that the remaining steps may be performed by the processor of the first device. For example, in performing step 610, the processor of the first computing device may determine that steps 404-418 and/or steps 454-462, e.g., all of the steps of methods 400/450 after receiving the at least one image, need to be performed using the dormant processing power of a second device. Alternatively, in performing step 610, the processor of the first computing device may determine that only the steps of methods 400 and/or 450 relating to image analysis (which require the most processing power) need to be performed using the dormant processing power of a second device. In this embodiment, the steps relating to image analysis, e.g., steps 404-410 of method 400 and/or steps 454-460 of method 450, are performed using the dormant processing power of a second device and the remaining steps of methods 400 and/or 450 are performed using the dormant processing power of the first device.

It is to be appreciated that, in some embodiments, in performing step 610, the processor of the first computing device is configured to pool or interrogate each of the other computing devices on the local network (e.g., WiFi) of home 104 to determine which computing device has dormant processing power above the threshold. For example, the processor of the first computing device may announce or post a message over the local network of home 104 requesting any computing devices on the local network to respond if they have dormant processing power above the threshold. Each computing device may determine its current dormant computing power using operating system functions, such as, “Task Manager” of the Windows™ operating system. If any of the computing devices have dormant power above the threshold, they are configured to send a response message to the first computing device via the local network indicating that they have dormant processing power above the threshold. After receiving the response message, the processor of the first computing device is configured to send instructions (including the at least one received image to be analyzed) to at least one second device on the network that has dormant processing power above the threshold to perform at least one step of methods 400 and/or 450. It is to be appreciated that the dormant processing power of more than one computing device may be used to perform the steps of methods 400 and/or 450 that the first computing device does not have the dormant processing power to perform. For example, the dormant processing power of at least one second computing device may be used to perform a first subset of the steps of methods 400 and/or 450 and at least one second computing device may be used to perform a second subset of the steps of methods 400 an/or 450.

It is to be appreciated that, in some embodiments, the at least one second device may be one or more devices located outside of the premises (e.g., outside home 104) on a separate network than the local network of the home. For example, the at least one second device may be a device coupled to home 104 via transmission lines 102 and 506 or via wireless means. The at least one second device may be in headend 106 or a facility or station coupled to headend 106. The at least one second device may be a device in a neighboring home to home 104 (or other home in the neighborhood of home 104), such as, a set-top box in the neighboring home. The device in neighboring home may by coupled to the first device via a network coupling each of the homes within the neighborhood of home 104, e.g., a network serviced by headend 106. In another embodiment, the at least one second device may be a device coupled to internet 504.

In one embodiment, the first device is configured to first pool the devices on the local network of the home 104, and, only if none of the devices on the local network of the home 104 have dormant processing power above the threshold, the first device sends instructions to a device on a separate network outside the local network of the home 104 to execute some or all of the steps of methods 400 and/or 450. In this way, all attempts are made to keep private data on the local network of home 104 and only when the first device determines this is not possible to perform methods 400 and/or 450 using dormant processing power, is private data sent to a device on separate network outside of home 104 to perform methods 400 and/or 450.

Referring against to FIG. 6, the processor of the first device receives the results of the executed at least one step of methods 400 and/or 450 from the at least one second device, in step 612. Based on the results received in step 612, the processor of the first device executes any remaining steps of methods 400 and/or 450 that were not executed by the at least one second device. For example, where the processor of the first device sent instruction to at least one second device to execute only the steps of methods 400 and/or 450 related to image processing (e.g., steps 404-410 and/or steps 454-460), the processor of the first device receives the results of the image processing steps of methods 400 and/or 450 from the at least one second device, in step 612. Based on the received results, the processor of the first device is configured to perform the remaining steps of methods 400 and/or 450 (e.g., steps 412-418 and/or step 462). This may involve sending one or more notifications (e.g., performing steps 412 and/or 462) or performing other actions (e.g., steps 414-418) based on the received results.

For example, where the result of steps 404-410 of method 400 executed by a second device is that the at least one detected face is not at least one known face in database 330, the processor of the first device is configured to receive this result and send a notification to a device other than the at least one first and second devices (e.g., a mobile phone 502), in step 412 of method 400. The processor of the first device may further perform steps 414-418 of method 400. As another example, where the result of step 454-460 of method 450 executed by a second device is that the number of unique faces in the premises is above a limit, the processor of the first device is configured to receive this result and send a notification to a device other than the at least one first and second devices (e.g., a mobile phone 502), in step 462 of method 450.

In another embodiment, the distributed dormant computing power scheme may be used to perform methods 400 and/or 450 based on a location of a computing device within the home 104. For example, one or more computing devices (e.g., set-top box 122, gateway 110, a smart appliance, etc.) may be configured to perform steps 400 and/or 450 for images captured in a first location of the home and one or more other computing devices may be configured to perform steps 400 and/or 450 for images captured in a second location of the home. In this way, the computing power required to perform methods 400 and/or 450 are further distributed and the processing load on any one device is reduced. For example, a set-top box 122 on the first floor may be configured to perform steps 400 and/or 450 for images captured on the first floor of the home 104 and a second set-top box 112 or other computing device on a second floor of the home 104 may be configured to perform steps of methods 400 and/or 450 for images captured on the second floor of the home 104. The processing load of performing steps 400 and/or 450 may be further distributed using method 600 to other devices in the first or second location of the home, such that, a distributed computing power scheme is used as described above. For example, in the example above, the set-top box 122 may send instruction to a smart refrigerator in the kitchen to perform some or all of the steps of methods 400 and/or 450.

In one aspect of the present disclosure, a method is provided including receiving, by a processor of a first device, at least one image captured within a premises; detecting, by the processor, at least one face in the at least one image; determining, by the processor, if the detected at least one face matches at least one known face in a database; and if the detected at least one face does not match a known face, transmitting a notification to at least one second device.

In another aspect of the present disclosure, the method includes wherein the notification includes the at least one image.

In another aspect of the present disclosure, the method includes wherein the at least one second device is a display device coupled to the first device.

In another aspect of the present disclosure, the method includes wherein the at least one second device is a phone device.

In another aspect of the present disclosure, the method includes wherein the notification includes at least one text message.

In another aspect of the present disclosure, the method includes prompting a user via the notification to add the detected at least one face to the database.

In another aspect of the present disclosure, the method includes prompting a user via the notification to issue a security warning.

In another aspect of the present disclosure, the method includes wherein the receiving, by the processor of the first device, is via at least one of a power line, a wired connection and/or a wireless communication.

In another aspect of the present disclosure, the method includes wherein the first device is a set-top box.

In another aspect of the present disclosure, the method includes wherein the processor performs the receiving, detecting, determining, and transmitting using only dormant processing power of the processor.

In another aspect of the present disclosure, the method includes wherein the processor performs the receiving, detecting, determining, and transmitting using only dormant processing power of the processor.

In another aspect of the present disclosure, an apparatus is provided including a processor that receives at least one image captured within a premises, detects at least one face in the at least one image, determines if the detected at least one face matches at least one known face in a database and, if the detected at least one face does not match a known face, transmits a notification to at least one second device.

In another aspect of the present disclosure, the apparatus includes wherein the notification includes the at least one image.

In another aspect of the present disclosure, the apparatus includes wherein the at least one second device is a display device coupled to the apparatus.

In another aspect of the present disclosure, the apparatus includes wherein the at least one second device is a phone device.

In another aspect of the present disclosure, the apparatus includes wherein the notification includes at least one text message.

In another aspect of the present disclosure, the apparatus includes wherein the processor configures the notification to prompt a user to add the detected at least one face to the database.

In another aspect of the present disclosure, the apparatus includes wherein the processor configures the notification to prompt a user to issue a security warning.

In another aspect of the present disclosure, the apparatus includes wherein the processor receives the at least one image via at least one of a power line, a wired connection and/or a wireless communication.

In another aspect of the present disclosure, the apparatus includes wherein the apparatus is a set-top box.

In another aspect of the present disclosure, the apparatus includes wherein the processor performs the receiving, detecting, determining, and transmitting using only dormant processing power of the processor.

In another aspect of the present disclosure, a method is provided including receiving, by a processor of a first device, at least one image captured within a premises; detecting, by the processor one or more faces in the at least one image; determining, by the processor, a number of unique faces present in the at least one image; and if the determined number of unique faces is above a limit, transmitting a notification to at least one second device.

In another aspect of the present disclosure, the method includes wherein the notification includes the at least one image.

In another aspect of the present disclosure, the method includes wherein the at least one second device is a display device coupled to the first device.

In another aspect of the present disclosure, the method includes wherein the at least one second device is a phone device.

In another aspect of the present disclosure, the method includes wherein the notification includes at least one text message.

In another aspect of the present disclosure, the method includes wherein the at least one image includes a plurality of images received from one or more video capturing devices.

In another aspect of the present disclosure, the method includes wherein the processor of the first device performs the receiving, detecting, determining, and transmitting using only dormant processing power of the processor.

In another aspect of the present disclosure, the method includes wherein the receiving, by the processor of the first device, is via at least one of a power line, a wired connection and/or a wireless communication.

In another aspect of the present disclosure, the method includes wherein the first device is a set-top box.

In another aspect of the present disclosure, the method includes wherein the first device is a smart device.

In another aspect of the present disclosure, an apparatus is provided including a processor that receives at least one image captured within a premises, detects one or more faces in the at least one image, determines a number of unique faces present in the at least one image and, if the determined number of unique faces is above a limit, transmits a notification to at least one second device.

In another aspect of the present disclosure, the apparatus includes wherein the notification includes the at least one image.

In another aspect of the present disclosure, the apparatus includes wherein the at least one second device is a display device coupled to the apparatus.

In another aspect of the present disclosure, the apparatus includes wherein the at least one second device is a phone device.

In another aspect of the present disclosure, the apparatus includes wherein the notification includes at least one text message.

In another aspect of the present disclosure, the apparatus includes wherein the at least one image includes a plurality of images received from one or more video capturing devices.

In another aspect of the present disclosure, the apparatus includes wherein the processor performs the receiving, detecting, determining, and transmitting using only dormant processing power of the processor.

In another aspect of the present disclosure, the apparatus includes wherein the processor receives the at least one image via at least one of a power line, a wired connection and/or a wireless communication.

In another aspect of the present disclosure, the apparatus includes wherein the apparatus is a set-top box.

In another aspect of the present disclosure, the apparatus includes wherein the apparatus is a smart device.

In another aspect of the present disclosure, a method is provided including receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting at least one face in the at least one image, and determining if the detected at least one face matches at least one known face in a database.

In another aspect of the present disclosure, the method includes receiving, by the processor of the first device, results of the instructions executed by the at least one second device; and based on the received results, transmitting a notification to at least one third device.

In another aspect of the present disclosure, a method is provided including receiving, by a processor of a first device, at least one image captured within a premises; determining, by the processor of the first device, if the current dormant processing power of the first device is above a threshold; and if the dormant processing power of the first device is not above the threshold, transmitting instructions including the at least one image to at least one second device to execute at least one of: detecting one or more faces in the at least one image, and determining a number of unique faces present in the at least one image.

In another aspect of the present disclosure, the method includes receiving, by the processor of the first device, results of the instructions executed by the at least one second device; and based on the received results, transmitting a notification to at least one third device.

It is to be appreciated that the various features shown and described are interchangeable, that is a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described embodiments of devices, systems, and methods for privacy-preserving security, it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method implemented by at least one processor comprising:
receiving, by a first device, at least one image captured within a premises;
detecting at least one face in the at least one image;
determining if the detected at least one face matches at least one known face in a database; and
if the detected at least one face does not match a known face, transmitting a notification to at least one second device, wherein
the processor performs the receiving, detecting, determining, and transmitting using only dormant processing power of the processor.

2. The method of claim 1, wherein the notification includes the at least one image.

3. The method of claim 1, wherein the at least one second device comprises a display device coupled to the first device.

4. The method of claim 1, wherein the at least one second device comprises a phone device.

5. The method of claim 1, wherein the notification includes at least one text message.

6. The method of claim 1, further comprising prompting a user via the notification to add the detected at least one face to the database.

7. The method of claim 1, further comprising prompting a user via the notification to issue a security warning.

8. The method of claim 1, wherein the receiving, by the processor of the first device, is via at least one of a power line, a wired connection or a wireless communication.

9. The method of claim 1, wherein the first device comprises a set-top box.

10. The method of claim 1, further comprising:
determining, by the first device, if the current dormant processing power of the first device is above a threshold; and
if the dormant processing power of the first device is not above the threshold, transmitting instructions including the at least one image to a third device to execute at least one of:
detecting one or more faces in the at least one image, and
determining a number of unique faces present in the at least one image.

11. An apparatus comprising:
at least one processor configured for receiving at least one image captured within a premises, detecting at least one face in the at least one image, determining if the detected at least one face matches at least one known face in a database and, if the detected at least one face does not match a known face, transmitting a notification to at least one second device, wherein the processor performs the receiving, detecting, determining, and transmitting using only dormant processing power of the processor.

12. The apparatus of claim 11, wherein the notification includes the at least one image.

13. The apparatus of claim 11, wherein the at least one second device comprises a display device coupled to the apparatus.

14. The apparatus of claim 11, wherein the at least one second device comprises a phone device.

15. The apparatus of claim 11, wherein the notification includes at least one text message.

16. The apparatus of claim 11, wherein the processor configures the notification to prompt a user to add the detected at least one face to the database.

17. The apparatus of claim 11, wherein the processor configures the notification to prompt a user to issue a security warning.

18. The apparatus of claim 11, wherein the processor receives the at least one image via at least one of a power line, a wired connection and/or a wireless communication.

19. The apparatus of claim 11, wherein the apparatus comprises a set-top box.

20. The apparatus of claim 11, wherein the processor is further configured for:
determining if the current dormant processing power of the first device is above a threshold; and
if the dormant processing power of the first device is not above the threshold, transmitting instructions including the at least one image to at least one third device to execute at least one of:
detecting one or more faces in the at least one image, and
determining a number of unique faces present in the at least one image.

21. A non-transitory computer-readable medium storing instructions that, when executed by a processor, perform a method comprising:
receiving, by a first device, at least one image captured within a premises;
detecting at least one face in the at least one image;
determining if the detected at least one face matches at least one known face in a database; and
if the detected at least one face does not match a known face, transmitting a notification to at least one second device, wherein the processor performs the receiving, detecting, determining, and transmitting using only dormant processing power of the processor.
